(19) United States
(12) Patent Application Publication
(10) Pub. No.: US 2026/0280778 A1
(43) Pub. Date: Sep. 17, 2026

(54) SYSTEMS AND METHODS FOR MULTI-DIMENSIONAL TRANSMISSIONS IN A COMMUNICATIONS NETWORK

(71) Applicant: T-MOBILE INNOVATIONS LLC, Overland Park, KS (US)

(72) Inventor: Wafik ABDELSHAHID, Kenmore, WA (US)

(21) Appl. No.: 19/078,677

(22) Filed: Mar. 13, 2025

(51) Int. Cl. H04L 5/00; H04W 36/00

(52) U.S. Cl. CPC H04L 5/0005; H04L 5/0092; H04W 36/00692

(57) ABSTRACT

Multi-dimension transmission introduces an approach that enhances spectral efficiency, mitigates interference, and improves network scalability. This technique allows multiple parallel data streams to coexist within the same frequency-time resources by defining additional transmission dimensions using layer-specific scrambling codes. By leveraging these dimensions, a dynamic scheduler can optimize resource allocation in real time, balancing Physical Resource Block (PRB) allocation, power control, and interference mitigation to help ensure optimal network performance.

### SUMMARY

The present disclosure is directed, in part, to multi-dimensional transmissions in a communications network, substantially as shown and/or described in connection with at least one of the figures, and as set forth more completely in the claims.

According to various aspects of the technology, multi-dimension transmission is an advanced wireless communication technique that helps increase network capacity and efficiency by helping multiple parallel data streams to coexist within the same frequency-time resources. Unlike traditional transmission methods that rely solely on frequency and time allocation, this approach introduces an additional transmission dimension using unique scrambling codes to distinguish and separate simultaneous transmissions. A scheduler may dynamically assign Physical Resource Blocks (PRBs) across these dimensions, adjusting power levels, interference mitigation strategies, and scheduling to optimize performance. User equipment (UE) accesses its assigned dimension through a combination of layer-specific and user-specific codes, helping to ensure seamless decoding while treating other layers as noise. This technique enhances spectral efficiency, reduces interference, and supports more users, making it a key innovation for future 5G and 6G networks without requiring additional spectrum resources.

Multi-dimension transmission offers several advantages over conventional techniques such as MU-MIMO, FD-MIMO, and traditional carrier aggregation by allowing more efficient spectrum utilization without increasing bandwidth requirements. Unlike MIMO, which relies on spatial multiplexing and is constrained by the number of available antennas, multi-dimension transmission allows for scalable capacity expansion through additional transmission layers defined by orthogonal scrambling codes. Compared to conventional intra-band and inter-band carrier aggregation, which requires separate frequency resources, this approach aggregates data streams within the same spectrum, reducing the need for additional bandwidth. Additionally, interference management is more effective, as power levels and PRB allocations can be dynamically optimized across layers, leading to improved signal-to-interference-plus-noise ratio and more reliable connections. Furthermore, this technique enhances security, as each transmission layer is encoded separately, making unauthorized interception more difficult. Overall, multi-dimension transmission provides a more flexible, scalable, and spectrally efficient solution for next-generation wireless networks.

This summary is provided to introduce a selection of concepts in a simplified form that are further described below in the detailed description. This summary is not intended to identify key features or essential features of the claimed subject matter, nor is it intended to be used in isolation as an aid in determining the scope of the claimed subject matter.

### BRIEF DESCRIPTION OF THE DRAWINGS

FIG. 1 illustrates an exemplary computing device for use with the present disclosure;

FIG. 2 illustrates a diagram of an exemplary network environment in which implementations of the present disclosure may be employed;

FIG. 3 illustrates a flow chart of an exemplary method for which implementations of the present disclosure may be employed;

FIG. 4 illustrates a flow chart of another exemplary method for which implementations of the present disclosure may be employed; and

FIG. 5 illustrates a flow chart of another exemplary method for which implementation of the present disclosure may be employed.

### DETAILED DESCRIPTION

By way of background, conventional communication techniques rely on well-established methods such as frequency division multiple access (FDMA), time division multiple access (TDMA), code division multiple access (CDMA), and spatial multiplexing through multiple-input multiple-output (MIMO) systems. These techniques allocate resources in different ways to support multiple users and maximize spectrum efficiency. However, as network demand grows and the number of connected devices increases, conventional methods face several challenges related to spectral efficiency, interference, and scalability. One common technique used in modern networks is MIMO, which utilizes multiple antennas at both the transmitter and receiver to enable spatial multiplexing. This allows multiple data streams to be transmitted simultaneously within the same frequency band, improving throughput and capacity. However, MIMO performance is inherently limited by the number of available antennas and the physical separation required for effective signal differentiation. As a result, dense urban environments, where space for multiple antennas is constrained, may experience degraded MIMO performance due to spatial correlation and multipath fading. Additionally, interference between MIMO layers can reduce overall efficiency, requiring complex signal processing techniques such as beamforming and precoding to mitigate degradation.

Carrier aggregation is another widely used technique that enhances data rates by combining multiple frequency bands. Intra-band carrier aggregation allows carriers within the same frequency range to be combined, while inter-band carrier aggregation merges carriers from different frequency bands. While this approach increases available bandwidth and improves peak data rates, it depends on spectrum availability and regulatory constraints. Additionally, carrier aggregation requires devices to support multiple frequency bands and dynamic coordination between them, which increases power consumption and complexity in both user equipment and network infrastructure.

CDMA and orthogonal frequency division multiple access (OFDMA) have been helpful in enabling multi-user access in wireless networks. CDMA relies on unique spreading codes to allow multiple users to share the same frequency spectrum, while OFDMA divides the spectrum into multiple subcarriers, assigning them dynamically based on user demand. However, CDMA suffers from interference when too many users share the same spectrum, leading to reduced signal quality and network congestion. OFDMA, while highly efficient, requires complex scheduling and coordination to maintain fairness and efficiency among users, particularly in dynamic environments where traffic demand fluctuates rapidly.

One of the biggest challenges in conventional techniques is interference management. As more users share the same spectrum, inter-cell and intra-cell interference become increasingly problematic, reducing signal quality and overall network efficiency. Techniques such as power control, frequency reuse, and beamforming are commonly used to mitigate interference, but they add complexity to network operations and may not be sufficient in highly congested environments. Additionally, as networks evolve to support higher frequencies, such as millimeter-wave (mmWave) bands in 5G, path loss and signal blockage issues become more pronounced, further complicating interference mitigation strategies. Scalability is another issue that arises with conventional transmission techniques. As the number of connected devices grows with the expansion of the Internet of Things (IoT) and machine-to-machine communication, traditional resource allocation methods struggle to accommodate diverse traffic patterns and service requirements. Static spectrum allocation and fixed scheduling policies may lead to inefficient use of available resources, particularly in scenarios with highly variable traffic loads.

To address the challenges faced by conventional wireless communication techniques, multi-dimension transmission introduces an approach that enhances spectral efficiency, mitigates interference, and improves network scalability. This technique allows multiple parallel data streams to coexist within the same frequency-time resources by defining additional transmission dimensions using layer-specific scrambling codes. By leveraging these dimensions, a dynamic scheduler can optimize resource allocation in real time, balancing Physical Resource Block (PRB) allocation, power control, and interference mitigation to help ensure optimal network performance.

A feature of this approach is multi-dimensional PRB allocation, where the scheduler distributes PRBs across different transmission layers rather than assigning them in a fully overlapping manner. Unlike traditional carrier aggregation, which requires separate frequency bands, this method enables data streams to operate within the same spectrum, reducing the need for additional bandwidth. The scheduler continuously monitors network conditions and adjusts PRB overlap percentages, ensuring that interference remains within acceptable limits while maximizing spectral utilization. By dynamically allocating PRBs based on real-time network congestion and user demand, the system maintains high throughput while minimizing interference between layers.

Another component is power level offsetting, which allows different transmission dimensions to operate at slightly different power levels to mitigate cross-layer interference. The scheduler adjusts transmission power per dimension in real time, ensuring that signals remain distinguishable from one another while maintaining adequate signal-to-interference-plus-noise ratio (SINR) for each user. This technique is particularly beneficial in high-density environments, where traditional power control methods struggle to effectively separate signals from multiple users operating in the same frequency range.

The use of scrambling codes is also helpful for multi-dimension transmission. Each dimension may be assigned a unique layer-specific scrambling code, helping ensure that data streams remain orthogonal to one another. Within each layer, users may be assigned user-specific codes that allow them to decode only their intended data while treating transmissions from other users as noise. This approach is similar in concept to CDMA but enhances security and interference mitigation by introducing an additional layer of separation between transmissions. The scheduler dynamically assigns and updates these scrambling codes as network conditions change, further reducing the risk of cross-layer interference.

In addition to enhancing spectral efficiency and interference mitigation, the multi-dimension transmission framework supports inter-dimension layer mobility and cross-carrier aggregation (CCA) within and across frequency bands. Unlike conventional MIMO and Mu-MIMO, which rely on spatial multiplexing constrained by antenna configurations, mutli-dimension transmission helps enable seamless transitions between transmission layers through dynamic scrambling code reassignment and adaptive scheduling. For example, the dynamic scheduler may continuously monitor user mobility, interference conditions, and QoS requirements to dynamically reallocate UE between transmission dimensions and/or frequency bands. This capability helps ensure that UEs experiencing degradation in one dimension can be handed over to another layer or frequency band with minimal interruption, helping to improve reliability and connection stability. Additionally, inter-dimension mobility helps enhance multi-user performance by allowing dynamic load balancing across transmission layers, reducing congestion in highly utilized dimensions. Compared to traditional CCA methods that require explicit carrier aggregation across separate frequency bands, this technique helps enable aggregation to occur across transmission layers within the same spectrum, helping to facilitate improved spectrum efficiency without overly increasing bandwidth demands.

From an implementation perspective, the dynamic scheduler may serve as the intelligence behind multi-dimension transmission, orchestrating resource allocation, power adjustments, and code assignments to optimize network performance. The scheduler operates within the base station (gNB in 5G or future 6G networks), where it continuously analyzes key network parameters such as user density, traffic demand, interference levels, and SINR measurements. Based on this analysis, it determines the optimal number of active dimensions, dynamically adjusting PRB distribution and power levels to maintain efficient operation.

One of the advantages of this approach is its ability to support diverse service requirements through network slicing. Different transmission dimensions can be allocated to different service types, such as ultra-reliable low-latency communication (URLLC), enhanced mobile broadband (eMBB), and massive machine-type communication (mMTC). The scheduler may prioritize resource allocation based on service type, helping ensure that mission-critical applications receive higher priority with reduced PRB overlap, while best-effort services can be assigned to dimensions with more relaxed interference constraints.

Security is also enhanced through dimension-specific encryption and dynamic scrambling code updates. By encoding data streams independently within each dimension, multi-dimension transmission reduces the risk of unauthorized interception. The scheduler periodically refreshes scrambling codes and encryption keys, making it significantly more difficult for eavesdroppers to reconstruct complete transmissions without access to all necessary parameters.

Accordingly, a first aspect of the present disclosure is directed to a system for multi-dimension transmission in a communications network. The system includes a scheduler comprising one or more processors. The system further includes a non-transitory computer-readable media configured to divide available frequency-time resources into multiple transmission dimensions, wherein each transmission dimension is assigned a unique scrambling code. The computer-readable media is further configured to allocate Physical Resource Blocks (PRBs) across the multiple dimensions based on an interference-mitigation strategy. The computer-readable media is further configured to adjust transmission power levels across the multiple dimensions to mitigate inter-dimension interference. The computer-readable media is further configured to transmit at least one data stream within each dimension using distinct scrambling codes. The computer-readable media is further configured to assign a user equipment (UE) a layer-specific code to access a particular dimension and a user-specific code for decoding its allocated data.

A second aspect of the present disclosure is directed to a non-transitory computer readable media having computer-executable instructions stored thereon that, when executed by one or more computer processor components, cause the one or more computer processing components to perform operations for multi-dimension transmission in a communications network. The computer-readable media is configured to divide available frequency-time resources into multiple transmission dimensions, wherein each transmission dimension is identified by a unique scrambling code. The computer-readable media is further configured to dynamically allocate Physical Resource Blocks (PRBs) to each dimension in a manner that minimizes inter-dimension interference. The computer-readable media is further configured to assign each user equipment (UE) of a plurality of UEs to a specific transmission dimension based on signal quality and interference conditions. The computer-readable media is further configured to transmit multiple parallel data streams across the dimensions. The computer-readable media is further configured to adjust power levels dynamically for each dimension to mitigate interference and enhance spectral efficiency.

A third aspect of the present disclosure is directed to a method for multi-dimension transmission in a communications network. The method includes dividing available frequency-time resources into multiple transmission dimensions, wherein each transmission dimension is assigned a unique scrambling code. The method further includes allocating Physical Resource Blocks (PRBs) across the dimensions using a partial overlap strategy. The computer-readable media is further configured to assigning a layer-specific code to each dimension to enable a user equipment (UE) to distinguish between transmission layers. The method further includes transmitting data within each dimension using a combination of layer-specific and user-specific codes for enhanced separation. The method further includes dynamically adjusting power levels per dimension to optimize spectral efficiency and reduce cross-layer interference.

The subject matter of embodiments of the invention is described with specificity herein to meet statutory requirements. However, the description itself is not intended to limit the scope of this patent. Rather, the inventors have contemplated that the claimed subject matter might be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Various technical terms, acronyms, and shorthand notations are employed to describe, refer to, and/or aid the understanding of certain concepts pertaining to the present disclosure. Unless otherwise noted, said terms should be understood in the manner they would be used by one with ordinary skill in the telecommunication arts. An illustrative resource that defines these terms can be found in Newton's Telecom Dictionary, (e.g., 32d Edition, 2022).

The example aspects and embodiments described in the present disclosure are provided within the context of a wireless telecommunication network for illustrative purposes. However, it should be understood that the principles and techniques discussed herein are not limited to wireless networks alone. The concepts and methodologies can be equally applied to other types of communication networks, including but not limited to wired, satellite, and optical networks. These alternative networks are capable of supporting the functionalities and applications described, and their use falls within the scope of the present disclosure.

Embodiments of the technology described herein may be embodied as, among other things, a method, system, or computer-program product. Accordingly, the embodiments may take the form of a hardware embodiment, or an embodiment combining software and hardware. An embodiment takes the form of a computer-program product that includes computer-useable instructions embodied on one or more computer-readable media that may cause one or more computer processing components to perform particular operations or functions.

Computer-readable media include both volatile and nonvolatile media, removable and nonremovable media, and contemplate media readable by a database, a switch, and various other network devices. Network switches, routers, and related components are conventional in nature, as are means of communicating with the same. By way of example, and not limitation, computer-readable media comprise computer-storage media and communications media.

Computer-storage media, or machine-readable media, include media implemented in any method or technology for storing information. Examples of stored information include computer-useable instructions, data structures, program modules, and other data representations. Computer-storage media include, but are not limited to RAM, ROM, EEPROM, flash memory or other memory technology, CD-ROM, digital versatile discs (DVD), holographic media or other optical disc storage, magnetic cassettes, magnetic tape, magnetic disk storage, and other magnetic storage devices. These memory components can store data momentarily, temporarily, or permanently.

Communications media typically store computer-useable instructions – including data structures and program modules – in a modulated data signal. The term “modulated data signal” refers to a propagated signal that has one or more of its characteristics set or changed to encode information in the signal. Communications media include any information-delivery media. By way of example but not limitation, communications media include wired media, such as a wired network or direct-wired connection, and wireless media such as acoustic, infrared, radio, microwave, spread-spectrum, and other wireless media technologies. Combinations of the above are included within the scope of computer-readable media.

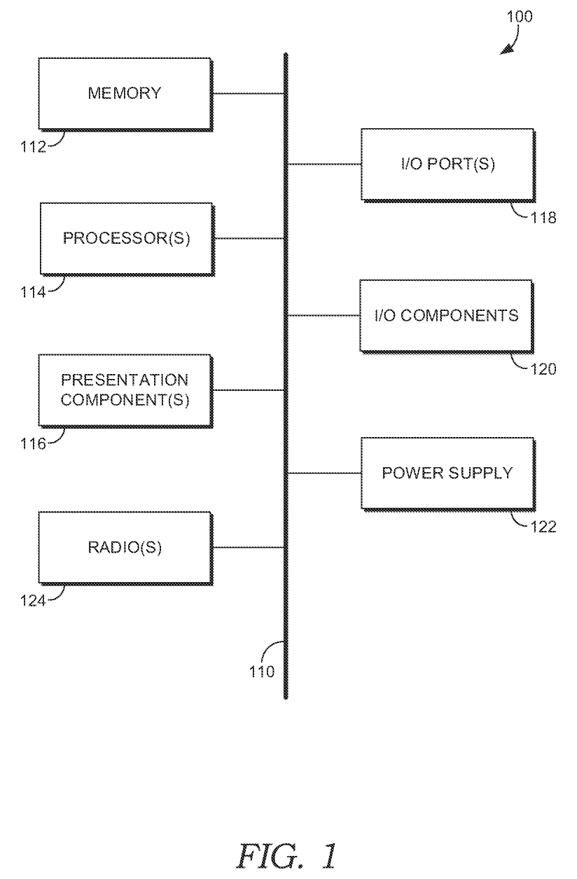

Referring to FIG. 1, an exemplary computer environment is shown and designated generally as computing device 100 that is suitable for use in implementations of the present disclosure. Computing device 100 is but one example of a suitable computing environment and is not intended to suggest any limitation as to the scope of use or functionality of the invention. Neither should computing device 100 be interpreted as having any dependency or requirement relating to any one or combination of components illustrated. In aspects, the computing device 100 is generally defined by its capability to transmit one or more signals to an access point and receive one or more signals from the access point (or some other access point); the computing device 100 may be referred to herein as a user equipment (UE), wireless communication device, or user device, The computing device 100 may take many forms; non-limiting examples of the computing device 100 include a fixed wireless access device, cell phone, tablet, internet of things (IoT) device, smart appliance, automotive or aircraft component, pager, personal electronic device, wearable electronic device, activity tracker, desktop computer, laptop, PC, and the like.

The implementations of the present disclosure may be described in the general context of computer code or machine-useable instructions, including computer-executable instructions such as program components, being executed by a computer or other machine, such as a personal data assistant or other handheld device. Generally, program components, including routines, programs, objects, components, data structures, and the like, refer to code that performs particular tasks or implements particular abstract data types. Implementations of the present disclosure may be practiced in a variety of system configurations, including handheld devices, consumer electronics, general-purpose computers, specialty computing devices, etc. Implementations of the present disclosure may also be practiced in distributed computing environments where tasks are performed by remote-processing devices that are linked through a communications network.

With continued reference to FIG. 1, computing device 100 includes bus 102 that directly or indirectly couples the following devices: memory 104, one or more processors 106, one or more presentation components 108, input/output (I/O) ports 110, I/O components 112, and power supply 114. Bus 102 represents what may be one or more busses (such as an address bus, data bus, or combination thereof). Although the devices of FIG. 1 are shown with lines for the sake of clarity, in reality, delineating various components is not so clear, and metaphorically, the lines would more accurately be grey and fuzzy. For example, one may consider a presentation component such as a display device to be one of I/O components 112. Also, processors, such as one or more processors 106, have memory. The present disclosure hereof recognizes that such is the nature of the art, and reiterates that FIG. 1 is merely illustrative of an exemplary computing environment that can be used in connection with one or more implementations of the present disclosure. Distinction is not made between such categories as “workstation,” “server,” “laptop,” “handheld device,” etc., as all are contemplated within the scope of FIG. 1 and refer to “computer” or “computing device.”

Computing device 100 typically includes a variety of computer-readable media. Computer-readable media can be any available media that can be accessed by computing device 100 and includes both volatile and nonvolatile media, removable and non-removable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program modules or other data. Computer storage media includes RAM, ROM, EEPROM, flash memory or other memory technology, CD-ROM, digital versatile disks (DVD) or other optical disk storage, magnetic cassettes, magnetic tape, magnetic disk storage or other magnetic storage devices. Computer storage media of the computing device 100 may be in the form of a dedicated solid state memory or flash memory, such as a subscriber information module (SIM). Computer storage media does not comprise a propagated data signal.

Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 104 includes computer-storage media in the form of volatile and/or nonvolatile memory. Memory 104 may be removable, nonremovable, or a combination thereof. Exemplary memory includes solid-state memory, hard drives, optical-disc drives, etc. Computing device 100 includes one or more processors 106 that read data from various entities such as bus 102, memory 104 or I/O components 112. One or more presentation components 108 presents data indications to a person or other device. Exemplary one or more presentation components 108 include a display device, speaker, printing component, vibrating component, etc. I/O ports 110 allow computing device 100 to be logically coupled to other devices including I/O components 112, some of which may be built in computing device 100. Illustrative I/O components 112 include a microphone, joystick, game pad, satellite dish, scanner, printer, wireless device, etc.

The radio 120 represents one or more radios that facilitate communication with one or more wireless networks using one or more wireless links. While a single radio 120 is shown in FIG. 1, it is expressly contemplated that there may be more than one radio 120 coupled to the bus 102. In aspects, the radio 120 utilizes a transmitted to communicate with a wireless telecommunications network. It is expressly contemplated that a computing device 100 with more than one radio 120 could facilitate communication with the wireless network via both the first transmitter and additional transmitters (e.g. a second transmitter). Illustrative wireless telecommunications technologies include CDMA, GPRS, TDMA, GSM, and the like. The radio 120 may carry wireless communication functions or operations using any number of desirable wireless communication protocols, including 802.11 (Wi-Fi), WiMAX, LTE, 3G, 4G, LTE, 5G, NR, VoLTE, or other VoIP communications. As can be appreciated, in various embodiments, radio 120 can be configured to support multiple technologies and/or multiple radios can be utilized to support multiple technologies. A wireless telecommunications network might include an array of devices, which are not shown as to obscure more relevant aspects of the invention. Components such as a base station or communications tower (as well as other components) can provide wireless connectivity in some embodiments.

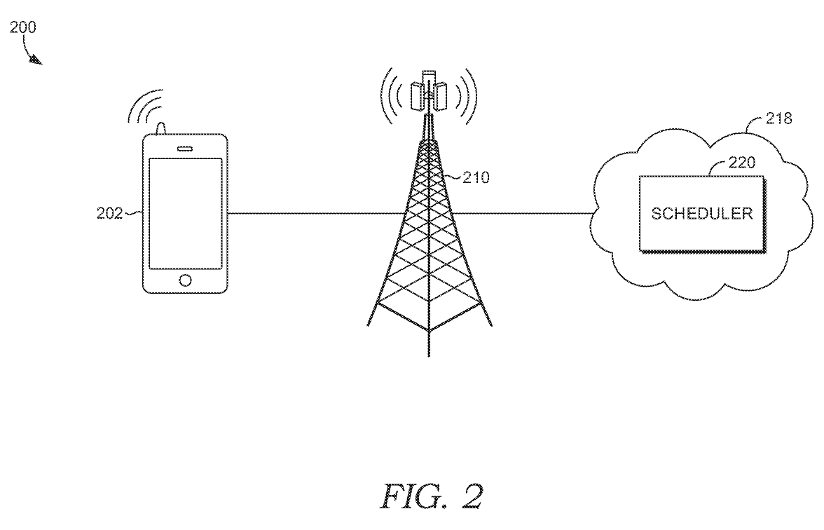

Referring now to FIG. 2, an exemplary network environment is illustrated in which implementations of the present disclosure may be employed. Such a network environment is illustrated and designated generally as network environment 200. Network environment 200 is but one example of a suitable network environment and is not intended to suggest any limitation as to the scope of use or functionality of the invention. Neither should the network environment be interpreted as having any dependency or requirement relating to any one or combination of components illustrated.

Network environment 200 represents a high level and simplified view of relevant portions of a modern wireless telecommunication network. At a high level, the network environment 200 may generally be said to comprise one or more UEs, such as UE 202, one or more base stations, such as a base station 210, a core network 218, and a scheduler 220, though in some implementations, it may not be necessary for certain features to be present. The network environment may include a number of routers, switches, and the like. The network environment 200 is generally configured for wirelessly connecting the UE 202 to data or services that may be accessible through the core network 218, or other functions, nodes, or servers not pictured in FIG. 2 so as to not obscure the focus on the present disclosure.

The UE 202 is illustrated generally, and may take any number of forms, including a tablet, phone, or wearable device, or any other device discussed with respect to FIG. 1 and may have any one or more components or features of the computing device 100 of FIG. 1. In some aspects, the UE 202 may not be a conventional telecommunications devices (i.e., a device that is capable of placing and receiving voice calls), but may instead take the form of devices that only utilizes wireless network resources in order to transmit or receive data; such devices may include IoT devices (e.g., smart appliances, thermostats, locks, smart speakers, lighting devices, smart receptacles, and the like).

The base station 210 may provide a network access location where the UE may potentially connect to (also referred to as ‘camping on,’ ‘attaching,’ in the industry). Though network environment 200 is illustrated with only the base station 210, one skilled in the art will appreciate that more or fewer base stations may be present in any particular network environment. The base station 210 is configured to wirelessly communicate with UEs, such as the UE 202. In aspects, the base station 210 may communicate with the UE 202 using any wireless telecommunication protocol desired by a network operator, including but not limited to 3G, 4G, 5G, 6G, 802.11x and the like.

The core network 218 may provide services and connectivity to the UE 202. For example, the core network 218 may manage the routing, authentication, and delivery of voice, data, and messaging services to the UE 202, regardless of whether the UE is operating within its home network. In some aspects, the core network 218 may include packet gateways and session management functions that help control the UE’s 202 access to external data networks and multimedia services. For example, the core network 218 may communicate with the base station 210 to provide services to the UE 202.

In the communications network, the scheduler 220 operating within the core network 218 plays a role in coordinating network resources and optimizing performance for the UE 202 communicating through a base station 210. The scheduler may be responsible for managing multi-dimensional transmission, ensuring efficient allocation of Physical Resource Blocks (PRBs), power levels, and scrambling codes to maximize spectral efficiency while minimizing interference. It may dynamically adapt to network conditions, adjusting resource assignments, transmission power, and dimension-specific parameters to provide reliable and high-performance connectivity across different service types and user demands.

At a high level, the scheduler 220 communicates with both the core network 218 and the base station 210 to orchestrate network resource distribution. The core network 218 oversees higher-level functionalities such as session management, authentication, and service orchestration, while the base station 210 may be responsible for executing real-time transmission and reception of signals to and from UE 202. The scheduler 220 continuously monitors key parameters, including network congestion, interference levels, service type priorities, and user density, and then dynamically assigns network resources to different transmission dimensions to optimize system performance.

To implement multi-dimension transmission, the scheduler 220 may first divide available frequency-time resources into multiple parallel dimensions, each identified by a unique scrambling code. It may then assign PRBs within these dimensions, determining the degree of PRB overlap based on real-time interference conditions and service quality requirements. For example, if the scheduler detects high network congestion, it may increase the number of active dimensions while reducing PRB overlap to minimize interference. Conversely, in low-traffic scenarios, it may reduce the number of dimensions to improve spectral efficiency.

The scheduler 220 may also manage power level offsetting, which helps mitigate inter-dimension interference by transmitting each layer at a slightly different power level. This is particularly useful in dense urban environments where overlapping transmissions in the same spectrum could otherwise degrade performance. By applying incremental power adjustments per dimension, the scheduler helps ensure that UE 202 can distinguish between signals from different layers, improving signal-to-interference-plus-noise ratio (SINR).

A function of the scheduler 220 is scrambling code management. Each transmission dimension may be assigned a unique layer-specific scrambling code, while each user may be assigned a user-specific scrambling code to facilitate decoding. When UE 202 initiates communication with base station 210, the scheduler 220 may determine which dimension the UE should operate in and assign the corresponding layer-specific scrambling code. This allows the UE 202 to filter out transmissions from other dimensions, treating them as interference. Additionally, the scheduler 220 may periodically update these codes to enhance security and prevent unauthorized interception.

The scheduler 220 may further support network slicing, helping to enable different dimensions to be allocated to different service types. For instance, a dimension with minimal PRB overlap and higher power levels may be assigned to ultra-reliable low-latency communication (URLLC) services, ensuring low latency and high reliability. Meanwhile, enhanced mobile broadband (eMBB) users may be assigned to dimensions with higher PRB overlap, allowing for efficient spectrum utilization. Massive machine-type communication (mMTC) devices, which typically have lower bandwidth requirements, can be scheduled into dimensions with optimized power and PRB allocation strategies to ensure scalability.

Security may also be enhanced through dimension-specific encryption and access control mechanisms. The scheduler helps ensure that only authorized UEs can access its assigned transmission dimension by issuing authentication keys and scrambling codes unique to each user. Additionally, the scheduler 220 may periodically update scrambling codes and dynamically reconfigure PRB allocations to further reduce the risk of interference and unauthorized access.

From an implementation standpoint, the scheduler 220 may operate in real time, continuously analyzing network conditions and making adjustments to optimize transmission parameters. It may leverage machine learning and predictive analytics to anticipate network congestion, interference patterns, and user behavior, allowing for proactive resource allocation. The scheduler 220 may communicate these adjustments to base station 210, ensuring that the transmission parameters are applied in a way that maximizes network efficiency and maintains seamless connectivity for UE 202.

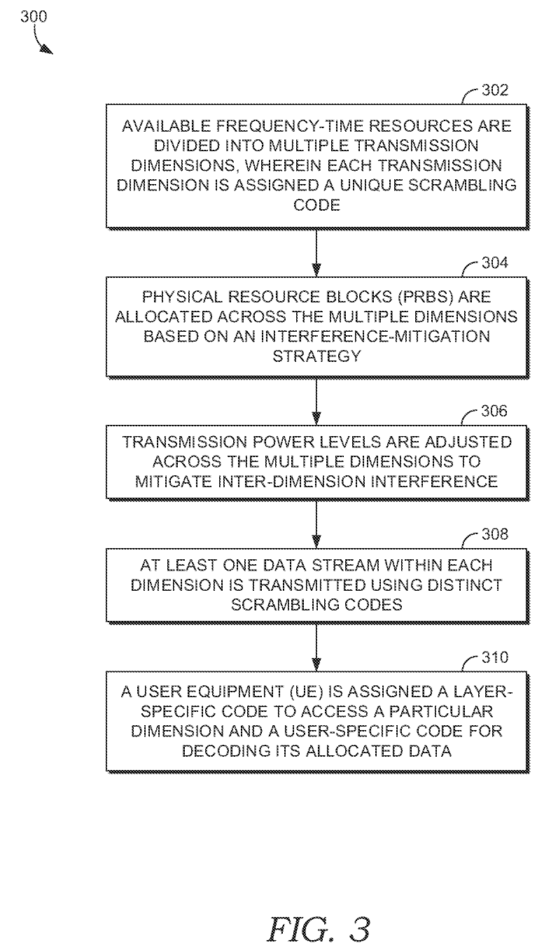

Turning now to FIG. 3, a flow chart is provided that illustrates one or more aspects of the present disclosure relating to a method 300 for multi-dimension transmission in a communications network. For example, at a first step 302, available frequency-time resources are divided into multiple transmission dimensions, wherein each transmission dimension is assigned a unique scrambling code. At a second step 304, Physical Resource Blocks (PRBs) are allocated across the multiple dimensions based on an interference-mitigation strategy. At a third step 306, transmission power levels are adjusted across the multiple dimensions to mitigate inter-dimension interference. At a fourth step 308, at least one data stream within each dimension is transmitted using distinct scrambling codes. At a fifth step 310, a user equipment (UE) is assigned a layer-specific code to access a particular dimension and a user-specific code for decoding its allocated data.

In some aspects, the method 300 may include dynamic adjustment of transmission dimensions based on network load conditions. A scheduler may continuously monitors real-time network traffic, congestion levels, and user distribution to determine the optimal number of active dimensions. If network congestion increases, additional dimensions can be activated to distribute traffic more efficiently and reduce interference. Conversely, when traffic is low, the scheduler may consolidate dimensions to conserve resources and optimize spectral efficiency. This dynamic dimension management ensures that spectrum usage is always aligned with demand, improving overall network performance.

In some aspects, the method 300 may include machine learning-based interference prediction to optimize PRB assignments, helping ensure that overlapping PRBs are assigned in a way that minimizes cross-layer interference. Additionally, power level offsetting may be implemented, where transmission power levels are incrementally adjusted across dimensions to further separate signals. This power control mechanism is particularly beneficial in dense network environments where users operating within the same frequency band could otherwise experience significant degradation in signal quality. The use of adaptive modulation and coding (AMC) further refines performance by dynamically adjusting transmission parameters based on the signal-to-interference-plus-noise ratio (SINR) within each dimension. Together, these enhancements enable the system to deliver high spectral efficiency, improved signal quality, and better interference mitigation, making it well-suited for next-generation wireless networks.

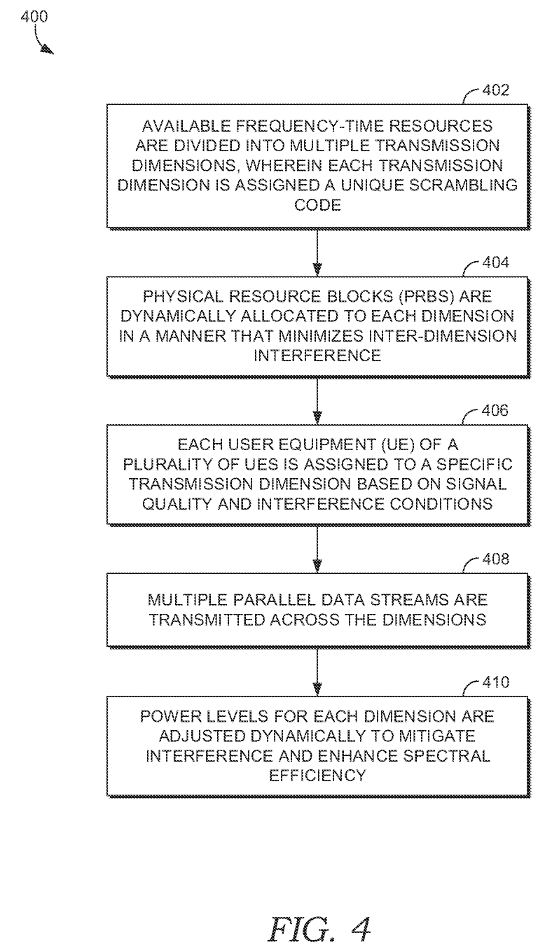

Turning now to FIG. 4, a flow chart is provided that illustrates one or more aspects of the present disclosure relating to a method 400 for multi-dimension transmission in a communications network. For example, at a first step 402, available frequency-time resources are divided into multiple transmission dimensions, wherein each transmission dimension is assigned a unique scrambling code. At a second step 404, Physical Resource Blocks (PRBs) are dynamically allocated to each dimension in a manner that minimizes inter-dimension interference. At a third step 406, each user equipment (UE) of a plurality of UEs is assigned to a specific transmission dimension based on signal quality and interference conditions. At a fourth step 408, multiple parallel data streams are transmitted across the dimensions. At a fifth step 410, power levels for each dimension are adjusted dynamically to mitigate interference and enhance spectral efficiency.

In some aspects, the method 400 may include the use of a configurable PRB overlap strategy, which may allow the network to dynamically adjust how PRBs are distributed among different transmission dimensions. A scheduler may continuously evaluate real-time network traffic, interference levels, and service demands to determine the optimal overlap percentage. For high-priority services, such as ultra-reliable low-latency communication (URLLC), the method may include reducing PRB overlap to ensure minimal interference, while for less sensitive applications, such as enhanced mobile broadband (eMBB), a higher overlap may be permitted to maximize spectral efficiency. This adaptive PRB allocation helps ensure that network resources are used efficiently while maintaining quality of service (QoS) guarantees.

In some aspects, the method 400 may include continuously monitoring SINR and interference conditions and adapting power levels accordingly, reducing the risk of signal degradation in high-density deployments. Additionally, forward error correction (FEC) encoding may be applied to improve transmission reliability in challenging radio environments, ensuring that data integrity is preserved even in the presence of noise and interference. The method 400 may also incorporate dedicated control signaling dimensions, where a separate layer is used for transmitting control information such as scheduling decisions, dimension assignments, and security updates. This separation of control and data transmissions enhances network coordination and reduces contention for resources. To further improve security, the method 400 may include dynamically updating scrambling codes and encryption keys, making it significantly more difficult for unauthorized entities to intercept or decode transmissions.

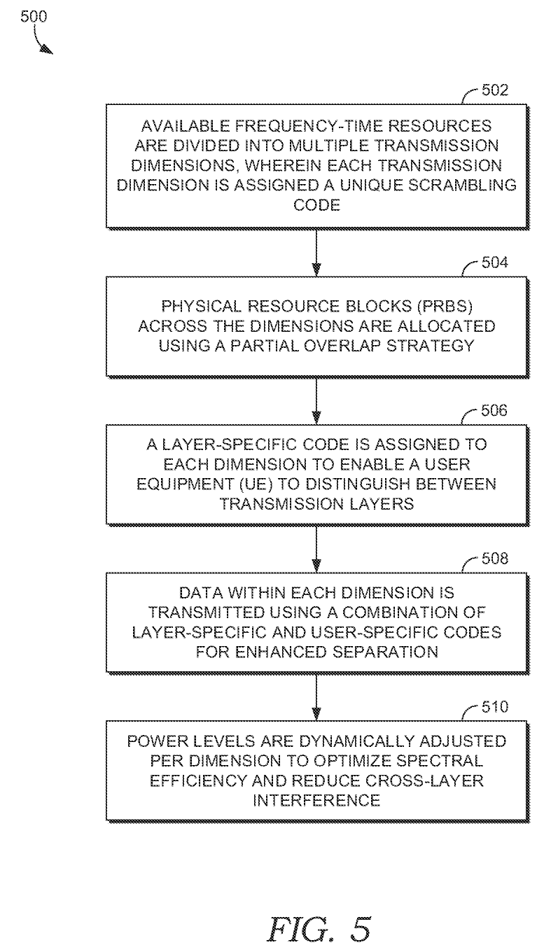

Turning now to FIG. 5, a flow chart is provided that illustrates one or more aspects of the present disclosure relating to a method 500 for multi-dimension transmission in a communications network. For example, at a first step 502, available frequency-time resources are divided into multiple transmission dimensions, wherein each transmission dimension is assigned a unique scrambling code. At a second step 504, Physical Resource Blocks (PRBs) across the dimensions are allocated using a partial overlap strategy. At a third step 506, a layer-specific code is assigned to each dimension to enable a user equipment (UE) to distinguish between transmission layers. At a fourth step 508, data within each dimension is transmitted using a combination of layer-specific and user-specific codes for enhanced separation. At a fifth step 510, power levels are dynamically adjusted per dimension to optimize spectral efficiency and reduce cross-layer interference.

In some aspects, the method 500 may include dynamic PRB reallocation, where a scheduler continuously monitors traffic demand, user density, and interference levels to adjust PRB assignments in real time. If network conditions change, such as a sudden increase in user activity in a particular area, the system can reallocate PRBs across transmission dimensions to maintain optimal throughput and minimize congestion. This adaptive approach helps prevent spectrum underutilization while ensuring that each user receives an appropriate level of resources based on network conditions.

In some aspects, the method 500 may include dimension-based carrier aggregation, where a single UE can be assigned multiple transmission dimensions to increase data throughput. This differs from traditional carrier aggregation, which requires separate frequency bands, as it allows aggregation to occur within the same frequency allocation. The method 500 may include dynamically assigning multiple layer-specific scrambling codes to UEs that require higher bandwidth, enabling them to receive data from multiple dimensions simultaneously. Additionally, the method 500 may incorporate enhanced security features by encrypting each transmission dimension independently and periodically updating scrambling codes. This helps ensure that even if one dimension is compromised, the entire transmission remains protected, reducing the risk of unauthorized access.

In some aspects, the method 500 may include QoS optimization. For example, a scheduler may adjust PRB overlap percentages dynamically based on service-level requirements. For instance, low-latency applications such as real-time gaming or emergency communications may be assigned to dimensions with minimal PRB overlap to reduce interference and improve reliability. Meanwhile, best-effort traffic, such as video streaming or background downloads, can be assigned to dimensions with higher PRB overlap, maximizing spectral efficiency. Furthermore, the method 500 may leverage network slicing, where different transmission dimensions are allocated to distinct service categories, such as ultra-reliable low-latency communication (URLLC), enhanced mobile broadband (eMBB), and massive machine-type communication (mMTC). By tailoring resource allocation per slice, the method 500 may help ensure optimized performance for diverse use cases while maintaining efficient spectrum utilization.

Many different arrangements of the various components depicted, as well as components not shown, are possible without departing from the scope of the claims below. Embodiments in this disclosure are described with the intent to be illustrative rather than restrictive. Alternative embodiments will become apparent to readers of this disclosure after and because of reading it. Alternative means of implementing the aforementioned can be completed without departing from the scope of the claims below. Certain features and subcombinations are of utility and may be employed without reference to other features and subcombinations and are contemplated within the scope of the claims.

In the preceding detailed description, reference is made to the accompanying drawings which form a part hereof wherein like numerals designate like parts throughout, and in which is shown, by way of illustration, embodiments that may be practiced. It is to be understood that other embodiments may be utilized and structural or logical changes may be made without departing from the scope of the present disclosure. Therefore, the preceding detailed description is not to be taken in the limiting sense, and the scope of embodiments is defined by the appended claims and their equivalents.

What is claimed is:

1. A system for multi-dimensional transmission in a communications network, the system comprising:
a dynamic scheduler comprising one or more processors; and
a non-transitory computer-readable media comprising executable instructions that, when executed, causes the dynamic scheduler to perform operations in the communications network, comprising:
dividing available frequency-time resources into multiple transmission dimensions, wherein each transmission dimension is assigned a unique scrambling code;
allocating Physical Resource Blocks (PRBs) across the multiple dimensions based on an interference-mitigation strategy;
adjusting transmission power levels across the multiple dimensions to mitigate inter-dimension interference;
transmitting at least one data stream within each dimension using distinct scrambling codes; and
assigning a user equipment (UE) a layer-specific code to access a particular dimension and a user-specific code for decoding its allocated data.

2. The system of claim 1, wherein the scheduler dynamically adjusts the number of transmission dimensions based on network load conditions.

3. The system of claim 1, wherein the PRB allocation is optimized using machine learning to predict interference levels and dynamically adjust the assignment to the UE.

4. The system of claim 1, wherein the scheduler applies a predefined power offset between dimensions.

5. The system of claim 1, wherein the layer-specific scrambling codes are periodically updated.

6. The system of claim 1, further comprising performing adaptive modulation and coding (AMC) based on the signal-to-interference-plus-noise ratio (SINR) of each transmission dimension.

7. The system of claim 1, further comprising assigning multiple transmission dimensions to a single UE to help enable dimension-based carrier aggregation.

8. The system of claim 1, wherein the mitigation-interference strategy comprises allocating PRBs based on a configurable PRB overlap strategy.

9. A non-transitory computer readable media having computer-executable instructions stored thereon that, when executed by one or more computer processor components, cause the one or more computer processing components to perform operations for multi-dimensional transmissions in a communications network, the operations comprising:
dividing available frequency-time resources into multiple transmission dimensions, wherein each transmission dimension is identified by a unique scrambling code;
dynamically allocating Physical Resource Blocks (PRBs) to each dimension in a manner that minimizes inter-dimension interference;
assigning each user equipment (UE) of a plurality of UEs to a specific transmission dimension based on signal quality and interference conditions;
transmitting multiple parallel data streams across the dimensions and;
adjusting power levels dynamically for each dimension to mitigate interference and enhance spectral efficiency.

10. The media of claim 9, wherein the PRB allocation follows a configurable PRB overlap strategy.

11. The media of claim 9, wherein each dimension is assigned a transmission power level that is dynamically adjusted based on real-time interference measurements.

12. The media of claim 9, further comprising applying forward error correction (FEC) encoding to each transmission dimension.

13. The media of claim 9, further comprising transmitting control signaling over a dedicated dimension.

14. The media of claim 9, wherein the scrambling codes assigned to transmission dimensions are selected based on a pseudo-random sequence.

15. A method for multi-dimensional transmission in a communications network, the method comprising:
dividing available frequency-time resources into multiple transmission dimensions, wherein each transmission dimension is assigned a unique scrambling code;
allocating Physical Resource Blocks (PRBs) across the dimensions using a partial overlap strategy;
assigning a layer-specific code to each dimension to enable a user equipment (UE) to distinguish between transmission layers;
transmitting data within each dimension using a combination of layer-specific and user-specific codes for enhanced separation; and
dynamically adjusting power levels per dimension to optimize spectral efficiency and reduce cross-layer interference.

16. The method of claim 15, further comprising dynamically reallocating PRBs among dimensions based on variations in network traffic demand.

17. The method of claim 16, further comprising assigning multiple transmission dimensions to a single UE to help enable dimension-based carrier aggregation.

18. The method of claim 16, further comprising encrypting data streams independently within each transmission.

19. The method of claim 16, further comprising adjusting PRB allocation overlap based on real-time quality of service (QoS) requirements.

20. The method of claim 16, further comprising applying network slicing techniques to allocate different transmission dimensions to different service types.
